(19) United States
(12) Patent Application Publication
(10) Pub. No.: US 2002/0163890 A1
(43) Pub. Date: Nov. 7, 2002

(54) Data communication device

(76) Inventors: Morio Yoshimoto, Tokyo (JP); Yukinari Matsuda, Tokyo (JP); Susumu Oka, Tokyo (JP)

Correspondence Address: BIRCH STEWART KOLASCH & BIRCH, PO BOX 747, FALLS CHURCH, VA, 22040-0747, US

(21) Appl. No.: 09/889,378

(22) PCT Filed: Jun. 25, 2001
(86) PCT No.: PCT/JP01/05421

(30) Foreign Application Priority Data
Jun. 26, 2000 (JP) 2000-191188

(51) Int. Cl. H04J 1/16; H04J 3/14

(52) U.S. Cl. 370/241; 370/242

(57) ABSTRACT

In multimedia communication between a data sending device and a data receiving device through a communication line, a line state relating to transmission quality in the communication line is always detected in the data sending device, an operation mode corresponding to an error tolerance level optimum to the current line state is selected in the data sending device, pieces of media data are multiplexed to a stream of multiplexed media data according to a data multiplexing method relating to the selected operation mode, and the stream of multiplexed media data is sent to the data receiving device through the communication line. Because the line state changes with time, the data multiplexing method also changes with time. When the line state deteriorates, a data multiplexing method corresponding to a high error tolerance level is adopted. Also, when the line state ameliorates, a data multiplexing method corresponding to a low error tolerance level is adopted. Accordingly, the media data can be prevented from being changed to faulty data or being lost during the multimedia communication, and the multimedia communication can be stably performed. Also, a transmission band for the multimedia communication can be efficiently used.

### BACKGROUND OF THE INVENTION

1. Field of the Invention

The present invention relates to a data communication device from/in which data is sent or received through a communication line.

2. Description of Related Art

A conventional information communication terminal has been, for example, disclosed in Published Unexamined Japanese Application No. H8-130587 (1996). In this Application, a plurality of communication lines are bundled, transmission data is divided into a plurality of pieces of transmission divided data on a data sending end, the pieces of transmission divided data are allocated among the bundled communication lines, and the pieces of transmission divided data are transmitted through the bundled communication lines as if the bundled communication lines denote one communication line. On a data receiving end, a data transmission delay time in each communication line is considered in advance, phases of the pieces of transmission divided data transmitted through the bundled communication lines are properly adjusted, and the pieces of transmission divided data are received as the transmission data as if the bundled communication lines denote one communication line.

Also, in cases where a single communication line is only used, the transmission data is sent from the data sending end through the communication line. On the data receiving end, a data transmission delay time in the communication line is considered in advance, and the transmission data is received.

Therefore, multimedia communication can be performed between the data sending end and the data receiving end through the communication line or the communication lines.

However, in the conventional information communication terminal, the multimedia communication is performed by bundling a plurality of communication lines or by using a single communication line. Therefore, in cases where a failure occurs in a communication line so as to deteriorate transmission quality in the communication line, a piece of transmission divided data or transmission data transmitted through the communication line is changed to false data or is lost. As a result, there is a problem that the transmission data cannot be reliably or stably received on the data receiving end.

### SUMMARY OF THE INVENTION

An object of the present invention is to provide, with due consideration to the drawbacks of the conventional information communication terminal, a data communication device in which data communication is stably performed even though transmission quality of data in a communication line is deteriorated in cases where the data communication is performed through a plurality of communication lines or a single communication line.

The object is achieved by the provision of a data communication device comprising, a line state monitoring unit for detecting a line state relating to transmission quality in a communication line and producing line state information indicating the line state, and a transmission control unit, having a plurality of operation modes corresponding to a plurality of error tolerance levels different from each other, for selecting a specific operation mode from the operation modes according to the line state information produced by the line state monitoring unit and performing a transmission control for transmission data, which is planned to be sent out to the communication line, according to the specific operation mode.

In the above configuration, the specific operation mode optimum to a current transmission quality in the communication line is selected, and the transmission control is performed for the transmission data input by a subscriber according to the specific operation mode.

Accordingly, even though the line state of the communication line deteriorates, the transmission data such as media data can be prevented from being changed to faulty data or being lost during multimedia communication through the communication line, and the multimedia communication can be stably performed.

It is preferred that the specific operation mode is changed to another operation mode by the transmission control unit in response to the change of the line state indicated by the line state information during the transmission of the data without suspending the transmission of the data, and the transmission control is performed for the transmission data according to the changed operation mode by the transmission control unit.

Accordingly, the multimedia communication can be stably performed.

It is also preferred that the transmission control unit has a plurality of data multiplexing methods corresponding to the operation modes, a specific multiplexing method is selected from the multiplexing methods by the transmission control unit according to the line state information produced by the line state monitoring unit, and pieces of transmission data, which are planned to be sent out to the communication line, are multiplexed with each other to a stream of multiplexed transmission data according to the specific multiplexing method.

Accordingly, the transmission control is performed for the transmission data according to the specific multiplexing method optimum to the current line state, and the multimedia communication can be stably performed.

It is also preferred that the specific operation mode is changed to another operation mode corresponding to a high error tolerance level by the transmission control unit according to the line state information in cases where the line state information indicates a deteriorated line state, and the specific operation mode is changed to another operation mode corresponding to a low error tolerance level by the transmission control unit according to the line state information in cases where the line state information indicates an ameliorated line state.

Accordingly, the error tolerance level is determined according to the current line state, and the multimedia communication can be stably performed.

It is also preferred that the data communication device further comprises an operation mode change request receiving unit for receiving an operation mode change request from a second data communication device and sending the operation mode change request to the transmission control unit to make the transmission control unit perform the transmission control for the transmission data according to a particular operation mode indicated by the operation mode change request.

Even though an operation mode optimum to the current line state is not determined in the data communication device, an operation mode optimum to the current line state is sent from the second data communication device to the data communication device. Accordingly, the transmission control can be appropriately performed according to the operation mode optimum to the current line state, and the multimedia communication can be stably performed.

It is also preferred that the data communication device further comprises a line interface, connected with the communication line, for sending the transmission data to the communication line. The transmission control unit controls the line interface to add a new communication line connected with the line interface, in cases where the specific operation mode corresponds to a high error tolerance level, and to disconnect the new communication line from the line interface in cases where the specific operation mode changed to a low error tolerance level.

Therefore, in cases where it is required to insert redundant data into the transmission data due to the high error tolerance level, the number of communication lines is increased. Accordingly, the multimedia communication can be stably performed.

Also, in cases where it is not required to insert redundant data into the transmission data due to the high error tolerance level, the number of communication lines is increased. Accordingly, a transmission bandwidth in the multimedia communication can be efficiently used. It is also preferred that the data communication device further comprises a line interface for receiving and sending the transmission data to/from the communication line. The transmission control unit controls the line interface to increase a data transfer rate for data sending while decreasing a data transfer rate for data reception by a degree of the increase of the data transfer rate for data sending in cases where the specific operation mode is changed to a particular operation mode corresponding to a high error tolerance level in the transmission control unit to perform the transmission control for the transmission data sent out to the communication line according to the particular operation mode.

Therefore, in cases where it is required to insert redundant data into the transmission data due to the high error tolerance level, a ratio of a data transfer rate for data sending to a data transfer rate for data reception is changed to smoothly transmit the data. Accordingly, the multimedia communication can be stably performed. It is also preferred that the data communication device further comprises a line interface for receiving and sending the transmission data from/to the communication line. The transmission control unit controls the line interface to decrease a data transfer rate for data sending while increasing a data transfer rate for data reception by a degree of the decrease of the data transfer rate for data sending in cases where the specific operation mode is changed to a particular operation mode corresponding to a low error tolerance level in the transmission control unit to perform the transmission control for the transmission data sent out to the communication line according to the particular operation mode.

Accordingly, in cases where it is not required to insert redundant data into the transmission data due to the high error tolerance level, a ratio of a data transfer rate for data sending to a data transfer rate for data reception is changed, and a transmission bandwidth in the multimedia communication can be efficiently used.

The object is also achieved by the provision of a data communication device comprising a line state monitoring unit for detecting a line state relating to transmission quality in a communication line and producing line state information indicating the line state, a transmission control unit, having a plurality of operation modes corresponding to a plurality of error tolerance levels different from each other, for selecting a specific operation mode from the operation modes according to the line state information produced by the line state monitoring unit and performing a transmission control for transmission data, which is sent out to the communication line or is received through the communication line, according to the specific operation mode, and an operation mode change request outputting unit for requesting of a second data communication device, with which communication is performed through the communication line, that an operation mode selected in the second data communication device is changed to the specific operation mode selected by the transmission control unit.

In the above configuration, the specific operation mode optimum to a current transmission quality in the communication line is used in the second data communication device communicating with the data communication device. Accordingly, even though the line state of the communication line deteriorates, the transmission data sent from the second data communication device can be prevented from being changed to faulty data or being lost during multimedia communication through the communication line, and the multimedia communication can be stably performed.

It is preferred that the request of the operation mode change request outputting unit to the second data communication device is performed during the sending or reception of the transmission data without suspending the sending or reception of the transmission data.

Therefore, the transmission data is successively sent from the second data communication device regardless of the change of the operation mode, and the transmission data is successively received in the second data communication device regardless of the change of the operation mode. Accordingly, the multimedia communication can be stably performed.

It is also preferred that the transmission control unit has a plurality of data multiplexing methods corresponding to the operation modes, a specific multiplexing method is selected from the multiplexing methods by the transmission control unit according to the line state information produced by the line state monitoring unit, and the operation mode change request outputting unit requests the second data communication device, during the transmission of the data without suspending the transmission of the data, to select the specific multiplexing method.

Accordingly, the transmission control is performed in the second data communication device for the transmission data according to the specific multiplexing method optimum to the current line state, and the multimedia communication can be stably performed.

It is also preferred that the operation mode change request outputting unit requests the second data communication device to change the specific operation mode to an operation mode corresponding to a high error tolerance level in cases where the line state information produced by the line state monitoring unit indicates a deteriorated line state, and the operation mode change request outputting unit requests the second data communication device to change the specific operation mode to an operation mode corresponding to a low error tolerance level in cases where the line state information produced by the line state monitoring unit indicates an ameliorated line state.

Accordingly, the transmission control is performed in the second data communication device according to an operation mode optimum to the current line state, and the multimedia communication can be stably performed.

It is also preferred that the data communication device further comprises an operation mode change request receiving unit for receiving an operation mode change request from the second data communication device, and sending the operation mode change request to the transmission control unit to make the transmission control unit perform the transmission control for the transmission data, which is received through the communication line or is sent out to the communication line, according to a particular operation mode indicated by the operation mode change request.

Even though an operation mode optimum to the current line state is not determined in the data communication device, an operation mode optimum to the current line state is sent from the second data communication device to the data communication device. Accordingly, the transmission control can be appropriately performed according to the operation mode optimum to the current line state, and the multimedia communication can be stably performed.

It is also preferred that the data communication device further comprises a line interface, connected with the communication line, for receiving or sending the transmission data from/to the communication line. The transmission control unit controls the line interface to add a new communication line connected with the line interface, in cases where the specific operation mode corresponds to a high error tolerance level, and to disconnect the new communication line, which is connected with the line interface, from the line interface in cases where the specific operation mode corresponding to the high error tolerance level is changed to that corresponding to a low error tolerance level.

Therefore, in cases where it is required to insert redundant data into the transmission data due to the high error tolerance level, the number of communication lines is increased. Accordingly, the multimedia communication can be stably performed.

Also, in cases where it is not required to insert redundant data into the transmission data due to the high error tolerance level, the number of communication lines is increased. Accordingly, a transmission bandwidth in the multimedia communication can be efficiently used.

It is also preferred that the data communication device further comprises a line interface, connected with the communication line, for receiving or sending the transmission data from/to the communication line. The operation mode change request receiving unit further receives a communication line adding request or a communication line disconnecting request from the second data communication device, the operation mode change request receiving unit sends the communication line adding request or the communication line disconnecting request to the transmission control unit, the transmission control unit controls the line interface to add a new communication line connected with the line interface according to the communication line adding request and changes the specific operation mode to an operation mode corresponding to a high error tolerance level according to the operation mode change request, and the transmission control unit controls the line interface to disconnect the new communication line, which is connected with the line interface, from the line interface according to the communication line disconnecting request and changes the specific operation mode to an operation mode corresponding to a low error tolerance level according to the operation mode change request.

Therefore, even though the current line state is not detected in the data communication device, information of the addition of communication lines or information of the disconnection of communication lines is sent from the second data communication device to the data communication device. Accordingly, the number of communication lines optimum to the multimedia communication can be set in the data communication device.

It is also preferred that the operation mode change request outputting unit requests the second data communication device to add a new communication line connected with the second data communication device in cases where the operation mode change request outputting unit requests the second data communication device to change the specific operation mode to an operation mode corresponding to a high error tolerance level, and the operation mode change request outputting unit requests the second data communication device to disconnect the new communication line, which is connected with the second data communication device, from the second data communication device in cases where the operation mode change request outputting unit requests the second data communication device to change the operation mode corresponding to the high error tolerance level to an operation mode corresponding to a low error tolerance level.

Therefore, even though the current line state is not detected in the second data communication device, the number of communication lines optimum to the multimedia communication can be set in the second data communication device.

It is also preferred that the data communication device further comprises a line interface for receiving and sending the transmission data from/to the communication line. The transmission control unit controls the line interface to increase a data transfer rate for data sending while decreasing a data transfer rate for data reception by a degree of the increase of the data transfer rate for data sending, in cases where the specific operation mode is changed to a particular operation mode corresponding to a high error tolerance level in the transmission control unit to perform the transmission control for the transmission data sent out to the communication line according to the particular operation mode, and to increase a data transfer rate for data reception while decreasing a data transfer rate for data sending by a degree of the increase of the data transfer rate for data reception in cases where the specific operation mode is changed to a particular operation mode corresponding to a high error tolerance level in the transmission control unit to perform the transmission control for the transmission data received through the communication line according to the particular operation mode.

Therefore, in cases where it is required to insert redundant data into the transmission data due to the high error tolerance level, a ratio of a data transfer rate for data sending to a data transfer rate for data reception is changed to smoothly transmit the data. Accordingly, the multimedia communication can be stably performed.

It is also preferred that the data communication device further comprises a line interface for receiving and sending the transmission data from/to the communication line. The transmission control unit controls the line interface to decrease a data transfer rate for data sending while increasing a data transfer rate for data reception by a degree of the decrease of the data transfer rate for data sending, in cases where the specific operation mode is changed to a particular operation mode corresponding to a low error tolerance level in the transmission control unit to perform the transmission control for the transmission data sent out to the communication line according to the particular operation mode, and to decrease a data transfer rate for data reception while increasing a data transfer rate for data sending by a degree of the decrease of the data transfer rate for data reception in cases where the specific operation mode is changed to a particular operation mode corresponding to a low error tolerance level in the transmission control unit to perform the transmission control for the transmission data received through the communication line according to the particular operation mode.

Accordingly, in cases where it is not required to insert redundant data into the transmission data due to the high error tolerance level, a ratio of a data transfer rate for data sending to a data transfer rate for data reception is changed, and a transmission bandwidth in the multimedia communication can be efficiently used.

It is also preferred that the data communication device further comprises a line interface for receiving and sending the transmission data from/to the communication line. The operation mode change request receiving unit further receives a data rate change request from the second data communication device, the operation mode change request receiving unit sends the data rate change request to the transmission control unit, the transmission control unit controls the line interface to increase a data transfer rate for data sending while decreasing a data transfer rate for data reception by a degree of the increase of the data transfer rate for data sending according to the data rate change request, in cases where the specific operation mode is changed to a particular operation mode corresponding to a high error tolerance level in the transmission control unit according to the operation mode change request to perform the transmission control for the transmission data sent out to the communication line according to the particular operation mode, and the transmission control unit controls the line interface to increase a data transfer rate for data reception while decreasing a data transfer rate for data sending by a degree of the increase of the data transfer rate for data reception according to the data rate change request in cases where the specific operation mode is changed to a particular operation mode corresponding to a high error tolerance level in the transmission control unit according to the operation mode change request to perform the transmission control for the transmission data received through the communication line according to the particular operation mode.

Therefore, even though it is required in the second data communication device to change a ratio of a data transfer rate for data sending to a data transfer rate for data reception in the multimedia communication, information of the ratio is sent to the data communication device. Accordingly, the ratio optimum to the multimedia communication can be set in the data communication device.

It is also preferred that the operation mode change request outputting unit requests the second data communication device to increase a data transfer rate for data sending while decreasing a data transfer rate for data reception by a degree of the increase of the data transfer rate for data sending, in cases where the operation mode change request outputting unit requests the second data communication device to change the specific operation mode to a particular operation mode corresponding to a high error tolerance level in the transmission control unit according to the operation mode change request to perform the transmission control for the transmission data sent out to the communication line according to the particular operation mode, and the operation mode change request outputting unit requests the second data communication device to increase a data transfer rate for data reception while decreasing a data transfer rate for data sending by a degree of the increase of the data transfer rate for data reception in cases where the operation mode change request outputting unit requests the second data communication device to change the specific operation mode to a particular operation mode corresponding to a high error tolerance level in the transmission control unit according to the operation mode change request to perform the transmission control for the transmission data received through the communication line according to the particular operation mode.

Therefore, even though it is required in the data communication device to change a ratio of a data transfer rate for data sending to a data transfer rate for data reception in the multimedia communication, information of the ratio is sent to the second data communication device. Accordingly, the ratio optimum to the multimedia communication can be set in the second data communication device.

### BRIEF DESCRIPTION OF THE DRAWINGS

FIG. 1 schematically shows a data communication system corresponding to first to fifth embodiments of the present invention;

FIG. 2 is a block diagram showing the configuration of a data coding and sending device and a data flow according to a first embodiment of the present invention;

FIG. 3 is a block diagram showing the configuration of a data receiving and decoding device and a data flow according to a second embodiment of the present invention;

FIG. 4A is a block diagram showing the configuration of a data sending and receiving device and a data flow of a data sending operation according to a third embodiment of the present invention;

FIG. 4B is a block diagram showing the configuration of the data sending and receiving device and a data flow of a data reception operation according to the third embodiment;

FIG. 5A is a block diagram showing the configuration of a data sending and receiving device of a data sending end and a data flow of a data sending operation according to a fourth embodiment of the present invention;

FIG. 5B is a block diagram showing the configuration of a data sending and receiving device of a data receiving end and a data flow of a data reception operation according to the fourth embodiment;

FIG. 6A is a block diagram showing the configuration of a first data sending and receiving device, from which a downward stream of multiplexed media data is sent out to a communication line and in which an upward stream of multiplexed media data transmitted through the communication line is received, according to a fifth embodiment of the present invention; and

FIG. 6B is a block diagram showing the configuration of a second data sending and receiving device, from which an upward stream of multiplexed media data is sent out to a communication line and in which a downward stream of multiplexed media data transmitted through the communication line is received, according to the fifth embodiment.

### DETAILED DESCRIPTION OF THE PREFERRED EMBODIMENTS

Embodiments of the present invention will now be described with reference to the accompanying drawings.

Embodiment 1

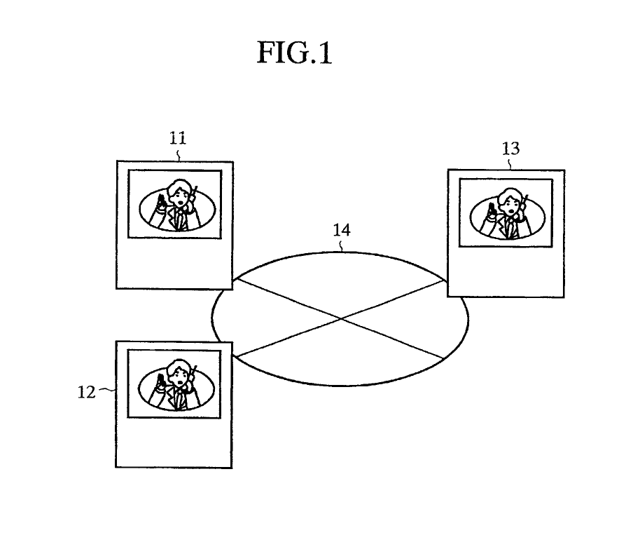

FIG. 1 schematically shows a data communication system corresponding to first to fifth embodiments of the present invention.

In FIG. 1, 11 indicates a data coding and sending device for coding data and sending the coded data. 12 indicates a data receiving and decoding device for receiving the coded data from the data coding and sending device 11 and decoding the coded data. 13 indicates a data sending and receiving device having a function of the data coding and sending device 11 and a function of the data receiving and decoding device 12. 14 indicates a general communication network such as a telephone network.

Next, an operation performed in the data communication system will be described below.

In the data coding and sending device 11, pieces of media data (or transmission data) are encoded to pieces of coded media data, and multimedia communication is performed by sending the pieces of coded media data to the data receiving and decoding device 12 or the data sending and receiving device 13 through a plurality of communication lines or a single communication line of the general communication network 14. In the data receiving and decoding device 12 or the data sending and receiving device 13, the pieces of coded media data received from the communication lines or the single communication line are decoded to the pieces of media data.

Also, because the data sending and receiving device 13 has the function of the data coding and sending device 11, pieces of media data are encoded to pieces of coded media data in the data sending and receiving device 13, and multimedia communication is performed by sending the pieces of coded media data to the data receiving and decoding device 12 through a plurality of communication lines or a single communication line of the general communication network 14. In the data receiving and decoding device 12, the pieces of coded media data received from the communication lines or the single communication line is decoded to the pieces of media data.

Therefore, because the pieces of media data are coded and are sent out to the general communication network 14, the pieces of coded media data can be received on a receiving end far from a sending end, and the pieces of media data can be obtained.

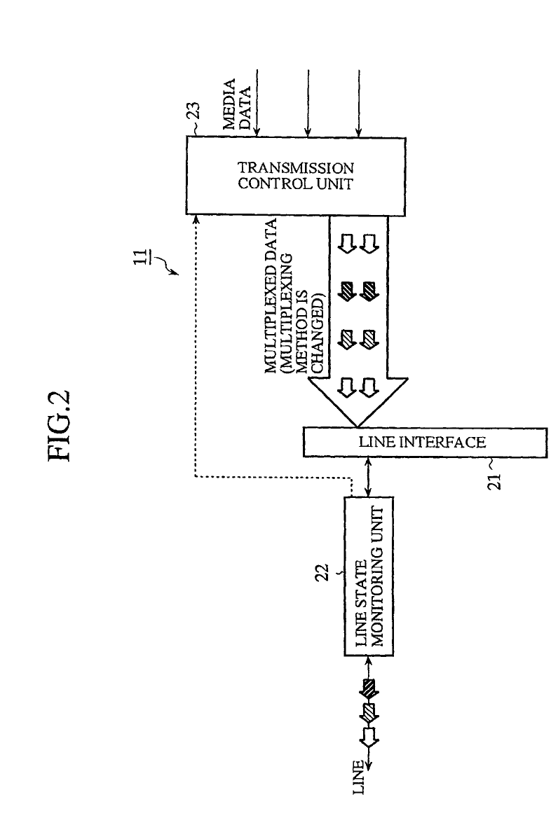

Next, multimedia communication reliably performed regardless of a failure occurring in a communication line or a plurality of communication lines is described with reference to FIG. 2.

FIG. 2 is a block diagram showing the configuration of the data coding and sending device 11 and a data flow according to a first embodiment of the present invention.

In FIG. 2, 21 indicates a line interface for sending a stream of multiplexed media data to a plurality of communication lines or a single communication line (hereinafter, the data sending through a plurality of communication lines is described). 22 indicates a line state monitoring unit for detecting a line state relating to transmission quality in each communication line connected with the line interface 21 and producing line state information indicating the line states of the communication lines. 23 indicates a transmission control unit for performing a transmission control for pieces of media data according to the line state information sent from the line state monitoring unit 22.

Next, an operation of the data coding and sending device 11 will be described below.

When pieces of media data are received from a plurality of subscribers or a subscriber, the pieces of media data received in the data coding and sending device 11 are multiplexed to a stream of multiplexed media data in the transmission control unit 23. Also, a current line state of each communication line connected with the data coding and sending device 11 is always detected in the line state monitoring unit 22, and line state information indicating the current line states of the communication lines is sent to the transmission control unit 23. In the transmission control unit 23, an operation mode (for example, a type of error correction) corresponding to an error tolerance level optimum to the current line state of each communication line is selected from a plurality of operation modes according to the line state information, and a data multiplexing method relating to the selected operation mode is selected from a plurality of data multiplexing methods for each communication line. Therefore, pieces of media data are multiplexed to multiplexed media data according to the selected data multiplexing methods in the transmission control unit 23. That is, a transmission control is performed for the pieces of media data. Here, because the current line states change with time, the selected data multiplexing methods corresponding to the communication lines change with time.

Thereafter, a stream of multiplexed media data is output from the transmission control unit 23 to the communication lines of the general communication network 14 through the line interface 21.

Therefore, in cases where current line states of a plurality of communication lines or a line state of one communication line deteriorate to lower transmission quality of media data in the communication lines or the communication line during the multimedia communication between the data coding and sending device 11 and the data receiving and decoding device 12 (or the data sending and receiving device 13), error tolerance levels for the line states or an error tolerance level for the line state are heightened in the transmission control unit 23, and pieces of media data planned to be sent out to the communication lines or the communication line are multiplexed according to selected data multiplexing methods corresponding to the heightened error tolerance levels without suspending the data transmission.

Also, in cases where transmission quality of a plurality of communication lines or one communication line is heightened during the multimedia communication, error tolerance levels for the line states or an error tolerance level for the line state are lowered in the transmission control unit 23, and pieces of media data planned to be sent out to the communication lines or the communication line are multiplexed according to selected data multiplexing methods corresponding to the lowered error tolerance levels without suspending the data transmission.

As is described above, in the first embodiment, a current line state relating to transmission quality in each communication line is always detected in the line state monitoring unit 22 of the data coding and sending device 11, an error tolerance level optimum to the line state is determined for each communication line, and a data multiplexing method (or an operation mode) corresponding to the error tolerance level is selected for each communication line in the transmission control unit 23. Therefore, even though transmission quality of one communication line is lowered during multimedia communication, a data multiplexing method for media data planned to be sent out to the communication line can be selected according to the detected current line state of the communication line, and pieces of media data can be multiplexed with each other according to the selected data multiplexing methods. Accordingly, each piece of media data can be prevented from being changed to faulty data or being lost during the multimedia communication, and the multimedia communication can be stably performed.

Also, in the first embodiment, in cases where a deteriorated transmission quality of one communication line is recovered to a normal transmission quality, an error tolerance level of the communication line is lowered to a normal tolerance level. Therefore, media data planned to be sent out to the communication line can be multiplexed with other pieces of media data according to a data multiplexing method corresponding to the normal tolerance level. Accordingly, because an amount of redundant data inserted into the media data is decreased, a transmission band for the multimedia communication can be efficiently used while the multimedia communication is stably performed.

In the first embodiment, current line states of the communication lines are always detected in the data coding and sending device 11 to multiplex pieces of media data with each other according to data multiplexing methods optimum to the current line states. However, the first embodiment is not limited to the detection of the current line state in the data coding and sending device 11. For example, it is applicable that current line states of the communication lines be always detected in the data sending and receiving device 13 to multiplex pieces of media data with each other according to data multiplexing methods optimum to the current line states.

Embodiment 2

In the first embodiment, in cases where transmission quality of communication lines is deteriorated, pieces of media data planned to be sent out to the communication line are multiplexed with each other according to data multiplexing methods optimum to the deteriorated line states in the data coding and sending device 11 so as to stably perform the multimedia communication. In contrast, in a second embodiment, in cases where transmission quality of communication lines or a communication line is deteriorated, multimedia communication is stably performed by using a function of the data receiving and decoding device 12.

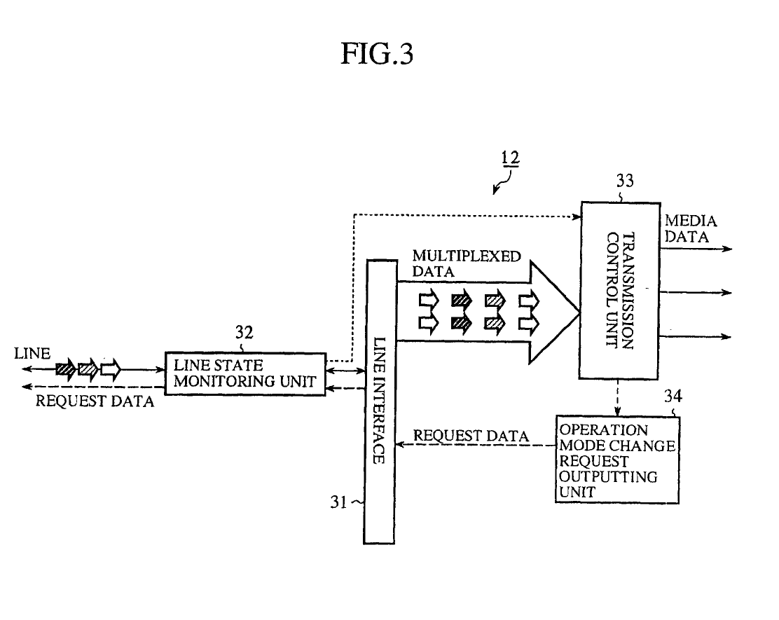

FIG. 3 is a block diagram showing the configuration of the data receiving and decoding device 12 and a data flow according to a second embodiment of the present invention.

In FIG. 3, 31 indicates a line interface for receiving a stream of multiplexed media data from a plurality of communication lines or a single communication line (hereinafter, the data reception through a plurality of communication lines is described). 32 indicates a line state monitoring unit for detecting a line state relating to transmission quality in each communication line connected with the line interface 31 and producing line state information indicating the line states of the communication lines. 33 indicates a transmission control unit for performing a transmission control for the stream of multiplexed media data received in the line interface 31 according to the line state information sent from the line state monitoring unit 32. 34 indicates an operation mode change request outputting unit for producing a change request of an operation mode for a transmission control according to an instruction of the transmission control unit 33 and outputting request data including the operation mode change request to the data coding and sending device 11 communicated with the data receiving and decoding device 12.

Next, an operation of the data receiving and decoding device 12 will be described below. In the line interface 31, pieces of multiplexed media data are received from a plurality of communication lines of the general communication circuit 14 as a stream of multiplexed media data, and the stream of multiplexed media data is sent to the transmission control unit 33. In the transmission control unit 33, the stream of multiplexed media data is demultiplexed to pieces of media data, and the pieces of media data are output to subscribers.

Also, in the line state monitoring unit 32, a current line state of each communication line is always detected, and line state information indicating the line states of the communication lines is sent to the transmission control unit 33. In the transmission control unit 33, an error tolerance level optimum to the line state of each communication line is determined according to the line state information. The error tolerance levels of the communication lines are sent to the operation mode change request outputting unit 34.

In the operation mode change request outputting unit 34, request data including an operation mode change request is produced. The operation mode change request indicates the changing to operation modes corresponding to the error tolerance levels determined in the data receiving and decoding device 12. Thereafter, the request data is output to the data coding and sending device 11 connected with the data receiving and decoding device 12 through the communication line.

For example, in cases where a plurality of line states of a plurality of communication lines (or a line state of a communication line) deteriorate, error tolerance levels for the communication lines are heightened, and an operation mode change request indicating the changing to operation modes corresponding to high error tolerance levels is sent to the data coding and sending device 11 through the communication lines or one communication line. Also, in cases where deteriorated line states of the communication lines (or a deteriorated line state of one communication line) are restored to normal line states, the error tolerance levels for the communication lines are lowered to normal error tolerance levels, and an operation mode change request indicating the changing to operation modes corresponding to the normal error tolerance levels is sent to the data coding and sending device 11 through the communication line.

Therefore, the request data is received in the data coding and sending device 11. In the data coding and sending device 11, in cases where operation modes selected in the data coding and sending device 11 can be changed in response to the request data, the operation modes selected in the data coding and sending device 11 are changed to the operation modes corresponding to the error tolerance levels determined in the data receiving and decoding device 12 according to the operation mode change request, data multiplexing methods relating to the changed operation modes are selected, and pieces of media data to be sent out to the communication lines connected with the data receiving and decoding device 12 are multiplexed with each other according to the selected data multiplexing methods, and a stream of multiplexed media data is sent to the data receiving and decoding device 12.

As is described above, in the second embodiment, current line states of the communication lines are always detected in the line state monitoring unit 22 of the data decoding and receiving device 12, error tolerance levels optimum to the detected line states are determined, and an operation mode change request indicating the changing to operation modes corresponding to the error tolerance levels is output from the data receiving and decoding device 12 to the data coding and sending device 11 through the communication line so as to make the data coding and sending device 11 select the operation modes corresponding to the error tolerance levels. Therefore, even though transmission quality of communication lines is deteriorated during multimedia communication, pieces of media data planned to be sent out to the communication lines can be multiplexed with each other in the data coding and sending device 11 according to the operation mode change request sent from the data receiving and decoding device 12 through the communication line. Accordingly, each piece of media data can be prevented from being changed to faulty data or being lost during the multimedia communication, and the multimedia communication can be stably performed.

Also, in the second embodiment, in cases where deteriorated transmission quality of communication lines are recovered to normal transmission quality, error tolerance levels of the communication lines are lowered in the data decoding and receiving device 12, operation modes corresponding to the low error tolerance levels are selected, an operation mode change request is output to the data coding and sending device 11 through the communication lines so as to make the data coding and sending device 11 select data multiplexing methods relating to the operation modes selected in the data decoding and receiving device 12. Therefore, pieces of media data planned to be sent out to the communication lines can be multiplexed with each other in the data coding and sending device 11 according to the selected data multiplexing methods corresponding to the normal transmission quality. Accordingly, because an amount of redundant data inserted into the pieces of media data is decreased, a transmission band for the multimedia communication can be efficiently used while the multimedia communication is stably performed.

In the second embodiment, current line states of the communication lines are always detected in the data decoding and receiving device 12, and an operation mode change request is sent to the data coding and sending device 11 to make the data coding and sending device 11 change the operation modes of the communication lines. However, the second embodiment is not limited to the detection of the line states in the data decoding and receiving device =.12. For example, it is' applicable that current line states of the communication lines be always detected in the data sending and receiving device 13 to make the data coding and sending device 11 (or another data sending and receiving device 13) change operation modes of the communication lines and multiplex pieces of media data sent out to the communication lines with each other according to data multiplexing methods relating to the changed operation modes.

Embodiment 3

In the first embodiment, current line states of the communication lines are always detected in the data coding and sending device 11 so as to stably perform multimedia communication. Also, in the second embodiment, current line states of the communication lines are always detected in the data decoding and receiving device 12 so as to stably perform multimedia communication. In contrast, in a third embodiment, current line states of the communication lines are always detected in the data sending and receiving device 13 so as to stably perform multimedia communication between the data sending and receiving devices 13.

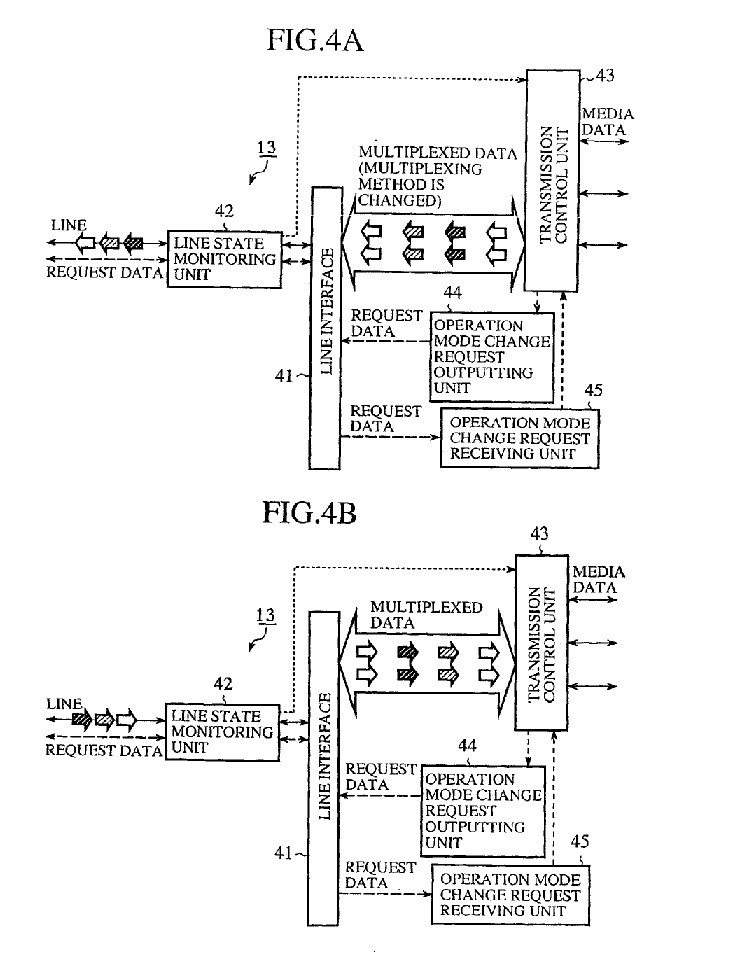

FIG. 4A is a block diagram showing the configuration of the data sending and receiving device 13 of a data sending end and a data flow of a data sending operation according to a third embodiment of the present invention, and FIG. 4B is a block diagram showing the configuration of the data sending and receiving device 13 of a data receiving end and a data flow of a data reception operation according to the third embodiment.

In FIG. 4A and FIG. 4B, one data sending and receiving device 13 is placed on a data sending end, and another data sending and receiving device 13 is placed on a data receiving end. 41 indicates a line interface for sending or receiving a stream of multiplexed media data to/from a plurality of communication lines or a single communication line (hereinafter, the data sending or receiving through a plurality of communication lines is described).

42 indicates a line state monitoring unit for detecting a current line state relating to transmission quality in each communication line connected with the line interface 41 and producing line state information indicating the line states of the communication lines.

43 indicates a transmission control unit for determining an error tolerance level optimum to the line state according to the line state information sent from the line state monitoring unit 42 for each communication line, selecting operation modes corresponding to the error tolerance levels, performing a transmission control for pieces of media data, which are planned to be sent from the line interface 41, according to the selected operation modes to produce a stream of multiplexed media data, and performing a transmission control for a stream of multiplexed media data received in the line interface 41 to produce pieces of media data.

44 indicates an operation mode change request outputting unit for producing an operation mode change request which indicates the changing of operation modes to the selected operation modes determined in the transmission control unit 43, and outputting request data including the operation mode change request from the data sending and receiving device 13 placed on a data sending (or receiving) end to the data sending and receiving device 13 placed on a data receiving (or sending) end.

45 indicates an operation mode change request receiving unit for receiving the request data including the operation mode change request from the data sending and receiving device 13 placed on the data sending (or receiving) end and sending the operation mode change request to the transmission control unit 43.

Next, a data transmission and reception operation of the data sending and receiving devices 13 and an operation mode change performed by the leadership of the data sending and receiving device 13 of a data sending end will be described below. In this data transmission and reception operation, request data including an operation mode change request is sent from the data sending and receiving device 13 of a data sending end (refer to FIG. 4A) to the data sending and receiving device 13 of a data receiving end (refer to FIG. 4B).

As shown in FIG. 4A, current line states of the communication lines connected with the data sending and receiving device 13 of the data sending end are always detected in the line state monitoring unit 42, and line state information indicating the line states of the communication lines is sent to the transmission control unit 43. In the transmission control unit 43, an error tolerance level optimum to the line state of each communication line is determined according to the line state information, an operation mode (for example, a type of error correction) corresponding to the error tolerance level is selected for each communication line, and a data multiplexing method relating to the selected operation mode is selected from a plurality of data multiplexing methods for each communication line.

Therefore, when pieces of media data are received from a plurality of subscribers or a subscriber, the pieces of received media data are multiplexed to multiplexed media data in the transmission control unit 43 according to the selected data multiplexing methods. That is, a transmission control is performed for the pieces of media data. Thereafter, a stream of multiplexed media data is output from the transmission control unit 43 to the line interface 41.

Also, the error tolerance levels of the communication lines are sent to the operation mode change request outputting unit 44. In the operation mode change request outputting unit 44, an operation mode change request indicating the changing to operation modes corresponding to the error tolerance levels is produced, and request data including the operation mode change request is output to the line interface 41.

Thereafter, the stream of multiplexed media data received from the transmission control unit 43 and the request data including the operation mode change request are output from the line interface 41 to the data sending and receiving device 13 placed on the data receiving end through the communication lines of the general communication network 14.

In the data sending and receiving device 13 placed on the data receiving end, as shown in FIG. 4B, the stream of multiplexed media data and the request data are received in the line interface 41 through the communication lines of the general communication network 14. The stream of multiplexed media data is sent to the transmission control unit 43, the request data including the operation mode change request is sent to the operation mode change request receiving unit 45.

In the operation mode change request receiving unit 45, the request data including the operation mode change request is received, and the operation mode change request extracted from the request data is sent to the transmission control unit 43.

In the transmission control unit 43, the operation mode change request is received, operation modes for the communication lines are changed to the operation modes selected in the data sending and receiving device 13 placed on the data sending end according to the operation mode change request, and a plurality of data demultiplexing methods corresponding to the communication lines are selected according to the changed operation modes. Thereafter, the stream of multiplexed media data is demultiplexed to pieces of media data according to the selected data demultiplexing methods, and the pieces of media data are output to subscribers.

For example, in cases where a plurality of line states of a plurality of communication lines (or a line state of a communication line) deteriorate, high error tolerance levels for the communication lines are determined in the data sending and receiving device placed on the data sending end, an operation mode change request corresponding to the high error tolerance levels is sent to the data sending and receiving device placed on the data receiving end through the communication lines or one communication line, data demultiplexing methods are selected according to the operation mode change request in the data sending and receiving device placed on the data receiving end, and pieces of media data are obtained according to the selected data demultiplexing methods.

Also, in cases where deteriorated line states of a plurality of communication lines (or a deteriorated line state of a communication line) are restored to normal line states, error tolerance levels for the communication lines are lowered to normal error tolerance levels in the data sending and receiving device placed on the data sending end, an operation mode change request corresponding to the normal error tolerance levels is sent to the data sending and receiving device placed on the data receiving end through the communication lines or one communication line, and pieces of media data of the communication lines are obtained according to data demultiplexing methods selected by using the operation mode change request.

Next, a data transmission and reception operation of the data sending and receiving devices 13 and an operation mode change performed by the leadership of the data sending and receiving device 13 of a data receiving end will be described below. In this data transmission and reception operation, request data including an operation mode change request is sent from the data sending and receiving device 13 of the data receiving end to the data sending and receiving device 13 of the data sending end.

As shown in FIG. 4B, in the data sending and receiving device 13 of the data receiving end, a stream of multiplexed media data sent from a plurality of communication lines of the general communication circuit 14 is received in the line interface 41, and the stream of multiplexed media data is sent to the transmission control unit 43. In the transmission control unit 43, the stream of multiplexed media data is demultiplexed to pieces of media data, and the pieces of media data are output to subscribers.

Also, current line states of the communication lines are always detected in the line state monitoring unit 42, and line state information indicating the current line states of the communication lines is sent to the transmission control unit 43. In the transmission control unit 43, an error tolerance level optimum to the line state of each communication line is determined, and the error tolerance levels of the communication lines are sent to the operation mode change request outputting unit 44.

In the operation mode change request outputting unit 44, request data including an operation mode change request is produced according to the error tolerance levels of the communication lines, and the request data is output to the data sending and receiving devices 13 placed on the data sending end through the line interface 41 and the communication line or the communication lines. The operation mode change request indicates the changing to operation modes corresponding to the error tolerance levels.

Thereafter, as shown in FIG. 4A, in the data sending and receiving device 13 placed on the data sending end, the request data including the operation mode change request is received in the line interface 41, and the request data including the operation mode change request is sent to the operation mode change request receiving unit 45.

In the operation mode change request receiving unit 45, the request data including the operation mode change request is received, and the operation mode change request extracted from the request data is sent to the transmission control unit 43. In the transmission control unit 43, operation modes corresponding to the error tolerance levels determined in the data sending and receiving device 13 of the data receiving end are selected according to the operation mode change requests, a transmission control is performed for pieces of media data to multiplex the pieces of media data according to data multiplexing methods relating to the selected operation modes. Thereafter, a stream of multiplexed media data is sent to the data sending and receiving device 13 of the data receiving end through the line interface 41 and the communication lines of the general communication network 14.

For example, in cases where a plurality of line states of a plurality of communication lines (or a line state of a communication line) deteriorate, high error tolerance levels for the communication lines are determined in the data sending and receiving device placed on the data receiving end, an operation mode change request corresponding to the high error tolerance levels is sent to the data sending and receiving device 13 placed on the data sending end through the communication line or the communication lines, and pieces of media data are multiplexed with each other according to data multiplexing methods corresponding to the high error tolerance levels. Also, in cases where deteriorated line states of a plurality of communication lines (or a deteriorated line state of a communication line) are restored to normal line states, error tolerance levels for the communication lines are lowered to normal error tolerance levels in the data sending and receiving device 13 placed on the data receiving end, an operation mode change request corresponding to the normal error tolerance levels is sent to the data sending and receiving device 13 of the data sending end through the communication line or the communication lines, and pieces of media data are multiplexed with each other according to data multiplexing methods corresponding to the normal error tolerance levels.

As is described above, in the third embodiment, a current line state of each communication line is always detected in the data sending and receiving device 13 of the data sending end (or the data receiving end), an error tolerance level optimum to the detected line state is determined for each communication line, and an operation mode change request corresponding to the error tolerance levels of the communication lines is output to the data sending and receiving device 13 of the data receiving end (or the data sending end) through the communication line . In cases where the operation mode change request is received in the data sending and receiving device 13 of the data receiving end, a stream of multiplexted media data is demultiplexed to pieces of media data according to data demultiplexing methods corresponding to the determined error tolerance levels in the data sending and receiving device 13 of the data receiving end. Also, in cases where the operation mode change request is received in the data sending and receiving device 13 of the data sending end, pieces of media data are multiplexted to a stream of multiplexted media data according to data multiplexing methods corresponding to the determined error tolerance levels in the data sending and receiving device 13 of the data sending end. Therefore, even though transmission quality of the communication lines is lowered during multimedia communication, an operation mode change request corresponding to high error tolerance levels is sent from the data sending end (or the data receiving end) to the data receiving end (or the data sending end), a stream of multiplexted media data transmitted through the communication lines can be demultiplexed to pieces of media data on the data receiving end according to the operation mode change request sent from the data sending end, and pieces of media data can be multiplexed with each other on the data sending end according to the operation mode change request sent from the data receiving end through the communication line. Accordingly, the media data can be prevented from being changed to faulty data or being lost during multimedia communication, and the multimedia communication can be stably performed.

Also, in the third embodiment, in cases where deteriorated transmission quality of communication lines is recovered to normal transmission quality, an operation mode change request corresponding to the normal transmission quality is sent from the data sending and receiving device 13 placed on the data sending end (or the data receiving end) to the data sending and receiving device 13 placed on the data receiving end (or the data sending end). In cases where the operation mode change request is received on the data receiving end, a stream of multiplexted media data is demultiplexed to pieces of media data according to data demultiplexing methods corresponding to normal error tolerance levels on the data receiving end. Also, in cases where the operation mode change request is received on the data sending end, pieces of media data are multiplexted with each other according to data multiplexing methods relating to normal error tolerance levels on the data sending end. Accordingly, a transmission band for the multimedia communication can be efficiently used while the multimedia communication is stably performed.

Embodiment 4

In the first to third embodiments, the number of communication lines for data sending connected with the data sending and receiving device 13 is fixed, and the number of communication lines for data reception connected with the data sending and receiving device 13 is fixed. That is, a transmission bandwidth for a stream of multiplexed media data sent from a data sending end to a data receiving end is fixed. In contrast, in a fourth embodiment, in cases where the line states of the communication lines already connecting the data sending end and the data receiving end considerably deteriorate, a plurality of new communication lines (or a new communication line) connecting the data sending end and the data receiving end are added to widen a transmission bandwidth for data transmission from the data sending end to the data receiving end. Also, in cases where the considerably-deteriorated line states are recovered to normal line states, the new communication lines, which connect the data sending end and the data receiving end, are disconnected from the data sending end and the data receiving end.

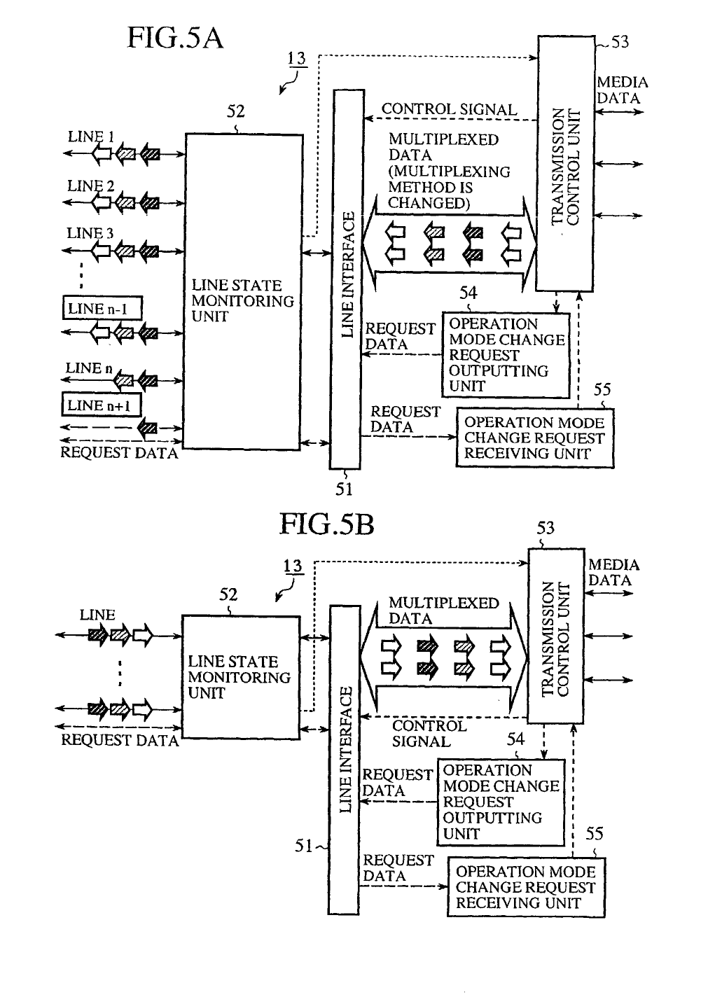

FIG. 5A is a block diagram showing the configuration of the data sending and receiving device 13 of a data sending end and a data flow of a data sending operation according to a fourth embodiment of the present invention, and FIG. 5B is a block diagram showing the configuration of the data sending and receiving device 13 of a data receiving end and a data flow of a data reception operation according to the fourth embodiment.

In FIG. 5A and FIG. 5B, one data sending and receiving device 13 is placed on a data sending end, and another data sending and receiving device 13 is placed on a data receiving end. 51 indicates a line interface for receiving or sending a stream of multiplexed media data from/to a plurality of communication lines or a single communication line (hereinafter, the data sending or reception through a plurality of communication lines is described).

52 indicates a line state monitoring unit for detecting current line states relating to transmission quality in the communication lines connected with the line interface 51 and producing line state information indicating the current line states of the communication lines.

53 indicates a transmission control unit for determining an error tolerance level according to the line state information sent from the line state monitoring unit 52 for each communication line, instructing the line interface 51 to additionally connect a plurality of new communication lines (or a new communication line) with the line interface 51 in cases where the current line states of the communication lines (or a current state of one communication line) considerably deteriorate, instructing the line interface 51 to disconnect the new communication lines from the line interface 51 in cases where the considerably-deteriorated line states of the communication lines are recovered to normal line states, performing a transmission control for pieces of media data, which is planned to be sent from the line interface 51, according to operation modes corresponding to the determined error tolerance levels, and performing a transmission control for a stream of multiplexed media data received in the line interface 51 according to operation modes corresponding to the determined error tolerance levels.

54 indicates an operation mode change request outputting unit for producing an operation mode change request according to the error tolerance levels determined in the transmission control unit 53 and outputting request data including the operation mode change request and communication line addition information to the data sending and receiving device 13 of the other end.

55 indicates an operation mode change request receiving unit for receiving request data including an operation mode change request and communication line addition information from the data sending and receiving device 13 of the other end and sending the operation mode change request and the communication line addition information to the transmission control unit 53.

Next, a data transmission and reception operation of the data sending and receiving devices 13 and a communication line adding operation performed under the control of the data sending and receiving device 13 of a data sending end will be described below. In this data transmission and reception operation, communication line addition information is sent from the data sending and receiving device 13 of a data sending end to the data sending and receiving device 13 of a data receiving end.

As shown in FIG. 5A, a line state of each communication line connected with the data sending and receiving device 13 of the data sending end is always detected in the line state monitoring unit 52, and line state information indicating the line states of the communication lines is sent to the transmission control unit 53. In the transmission control unit 53, an error tolerance level optimum to the line state of each communication line is determined according to the line state information, an operation mode (for example, a type of error correction) corresponding to the error tolerance level is selected for each communication line, and a data multiplexing method relating to the operation mode is selected from a plurality of data multiplexing methods for each communication line.

Therefore, when pieces of media data are received from a plurality of subscribers or a subscriber, the pieces of received media data are multiplexed to a stream of multiplexed media data in the transmission control unit 53 according to the selected data multiplexing methods. That is, a transmission control is performed for the pieces of media data. Thereafter, the stream of multiplexed media data is output from the transmission control unit 53 to the line interface 51.

Also, in cases where line states of a plurality of communication lines (or a communication line) connecting the data sending and receiving device 13 of the data sending end and the data sending and receiving device 13 of the data receiving end considerably deteriorate, the error tolerance levels of the communication lines are considerably heightened. Therefore, it is required to insert an appreciable amount of redundant data (or error correction codes) into the stream of multiplexed media data for the purpose of strengthening the error tolerance of the stream of multiplexed media data in the communication lines. In this case, a transmission bandwidth for the transmission of the stream of multiplexed media data is undesirably reduced due to the appreciable amount of redundant data. To sufficiently obtain a transmission bandwidth for the transmission of the stream of multiplexed media data, in cases where it is judged in the transmission control unit 53 that the line states of the communication lines considerably deteriorate, the data sending and receiving device 13 of the data sending end negotiates with the data sending and receiving device 13 of the data receiving end for the addition of new communication lines (or a new communication line) connecting the data sending end and the data receiving end.

In detail, information (hereinafter, called communication line addition information) indicating a request of the addition of new communication lines and the number of new communication lines or a request of no addition of new communication lines is produced in the transmission control unit 53 according to the line state information, and the determined error tolerance levels and the communication line addition information are sent from the transmission control unit 53 to the operation mode change request outputting unit 54.

In the operation mode change request outputting unit 54, an operation mode change request indicating the changing to operation modes corresponding to the determined error tolerance levels is produced, and request data including the operation mode change request and the communication line addition information is output to the line interface 51.

Thereafter, the stream of multiplexed media data received from the transmission control unit 53 and the request data including the operation mode change request and the communication line addition information are output from the line interface 51 to the data sending and receiving device 13 of the data receiving end through the communication lines of the general communication network 14.

In the data sending and receiving device 13 of the data receiving end, as shown in FIG. 5B, the stream of multiplexed media data and the request data including the operation mode change request and the communication line addition information are received in the line interface 51 through the communication lines of the general communication network 14. The stream of multiplexed media data is sent to the transmission control unit 53, and the request data including the operation mode change request and the communication line addition information are sent to the operation mode change request receiving unit 55.

In the operation mode change request receiving unit 55, the request data including the operation mode change request and the communication line addition information is received, the operation mode change request corresponding to the communication lines connected with the data sending and receiving device 13 of the sending end and the communication line addition information are sent to the transmission control unit 53.

In the transmission control unit 53, the operation mode change request and the communication line addition information are received, operation modes corresponding to the error tolerance levels determined in the data sending and receiving device 13 of the data sending end are selected according to the operation mode change request, and a plurality of data demultiplexing methods relating to the selected operation modes are selected. Thereafter, the stream of multiplexed media data is demultiplexed to pieces of media data according to the selected data demultiplexing methods, and the pieces of media data are output to subscribers. Also, in cases where the communication line addition information indicates the addition of new communication lines, the transmission control unit 53 instructs the line interface 51 to additionally connect a plurality of new communication lines, of which the number is indicated by the communication line addition information, with the data sending and receiving device 13 of the receiving end. Therefore, the new communication lines are connected with the data sending and receiving device 13 of the receiving end. Thereafter, information (hereinafter, called communication line addition completion information) indicating the completion of the addition of the new communication lines and the number of new communication lines is produced, and request data including the communication line addition completion information is sent to the data sending and receiving device 13 of the data sending end through one communication line of the communication network 14.

As shown in FIG. 5A, in the data sending and receiving device 13 of the data sending end, the request data including the communication line addition completion information is received in the line interface 51 and is sent to the operation mode change request receiving unit 55. In the operation mode change request receiving unit 55, the request data including the communication line addition completion information is received, and the communication line addition completion information is sent to the transmission control unit 53.

In response to the communication line addition completion information, the transmission control unit 53 instructs the line interface 51 to additionally connect the new communication lines, which are designated by the communication line addition completion information, with the data sending and receiving device 13 of the data sending end. Therefore, the data sending and receiving device 13 of the data sending end is additionally connected with the data sending and receiving device 13 of the data receiving end through the new communication lines (or the new communication line).

Next, a data transmission and reception operation of the data sending and receiving devices 13 and a communication line disconnecting operation performed under the control of the data sending and receiving device 13 of a data sending end will be described below. In this data transmission and reception operation, communication line disconnection information is sent from the data sending and receiving device 13 of a data sending end to the data sending and receiving device 13 of a data receiving end.

As shown in FIG. 5A, a line state of each communication line connected with the data sending and receiving device 13 of the data sending end is always detected in the line state monitoring unit 52, and line state information indicating the line states of the communication lines is sent to the transmission control unit 53. In the communication lines connecting the data sending and receiving device 13 of the data sending end and the data sending and receiving device 13 of the data receiving end, the new communication lines connecting the data sending and receiving device 13 of the data sending end and the data sending and receiving device 13 of the data receiving end are included.

In the transmission control unit 53, an error tolerance level optimum to the line state of each communication line is determined according to the line state information, an operation mode (for example, a type of error correction) corresponding to the error tolerance level is selected for each communication line, and a data multiplexing method relating to the operation mode is selected from a plurality of data multiplexing methods for each communication line.

Therefore, when pieces of media data are received from a plurality of subscribers or a subscriber, the pieces of received media data are multiplexed to a stream of multiplexed media data in the transmission control unit 53 according to the selected data multiplexing methods. That is, a transmission control is performed for the pieces of media data. Thereafter, the stream of multiplexed media data is output from the transmission control unit 53 to the line interface 51.

Also, in cases where considerably-deteriorated line states of the communication lines are recovered to normal line states, the high error tolerance levels of the communication lines are lowered to normal error tolerance levels. Therefore, it is not required to insert an appreciable amount of redundant data into the stream of multiplexed media data for the purpose of strengthening the error tolerance of the stream of multiplexed media data in the communication lines. In this case, a communication line disconnecting operation is performed under the control of the data sending and receiving device 13 of the data sending end.

In detail, in the transmission control unit 53, the new communication lines are disconnected from the data sending and receiving device 13 of the data sending end, a transmission control is performed for pieces of media data planned to be sent to the data sending and receiving device 13 of the data receiving end to produce a stream of multiplexed media data from the pieces of media data according to the selected data multiplexing methods, and the stream of multiplexed media data is sent to the data sending and receiving device 13 of the data receiving end through the communication lines not including any new communication lines. Also, information (hereinafter, called communication line disconnection information) indicating a request of the disconnection of new communication lines and the number of new communication lines or a request of no disconnection is produced in the transmission control unit 53 according to the line state information, and the determined error tolerance levels and the communication line disconnection information are sent from the transmission control unit 53 to the operation mode change request outputting unit 54.

In the operation mode change request outputting unit 54, an operation mode change request indicating the changing to operation modes corresponding to the determined error tolerance levels is produced, and request data including the operation mode change request and the communication line disconnection information is output to the line interface 51.

Thereafter, the request data including the operation mode change request and the communication line disconnection information is output from the line interface 51 to the data sending and receiving device 13 of the data receiving end through one communication line of the general communication network 14.

In the data sending and receiving device 13 of the data receiving end, as shown in FIG. 5B, the stream of multiplexed media data and the request data including the operation mode change request and the communication line disconnection information are received in the line interface 51 through the communication lines of the general communication network 14. The stream of multiplexed media data is sent to the transmission control unit 53, and the request data including the operation mode change request and the communication line disconnection information is sent to the operation mode change request receiving unit 55.

In the operation mode change request receiving unit 55, the request data including the operation mode change request and the communication line disconnection information is received, and the operation mode change request and the communication line disconnection information are sent to the transmission control unit 53.

In the transmission control unit 53, the operation mode change request and the communication line disconnection information are received, operation modes corresponding to the error tolerance levels determined in the data sending and receiving device 13 of the data sending end are selected according to the operation mode change request, and a plurality of data demultiplexing methods relating to the selected operation modes are selected. Thereafter, the stream of multiplexed media data is demultiplexed to pieces of media data according to the selected data demultiplexing methods, and the pieces of media data are output to subscribers. Also, in cases where the communication line disconnection information indicates the disconnection of new communication lines, the transmission control unit 53 instructs the line interface 51 to disconnect the new communication lines from the data sending and receiving device 13 of the receiving end according to the communication line disconnection information. Therefore, the new communication lines are disconnected from the data sending and receiving device 13 of the receiving end and the data sending and receiving device 13 of the sending end.

Next, a data transmission and reception operation of the data sending and receiving devices 13 and a communication line adding operation performed under the control of the data sending and receiving device 13 of the data receiving end will be described below. In this data transmission and reception operation, communication line addition information is sent from the data sending and receiving device 13 of the data receiving end to the data sending and receiving device 13 of the data sending end.

As shown in FIG. 5B, a current line state of each communication line connected with the data sending and receiving device 13 of the data receiving end is always detected in the line state monitoring unit 52, and line state information indicating the current line states of the communication lines is sent to the transmission control unit 53. Therefore, when a stream of multiplexed media data sent from a plurality of communication lines of the general communication circuit 14 is received in the line interface 51, the stream of multiplexed media data is sent to the transmission control unit 53. In the transmission control unit 53, an error tolerance level optimum to the line state of each communication line is determined according to the line state information, the stream of multiplexed media data is demultiplexed to pieces of media data according to data demultiplexing methods corresponding to the determined error tolerance levels, and the pieces of media data are output to subscribers. Also, the error tolerance levels of the communication lines are sent to the operation mode change request outputting unit 54.

Also, in cases where it is judged in the transmission control unit 53 that current line states of a plurality of communication lines (or a current line state of a communication line) connecting the data sending and receiving device 13 of the data sending end and the data sending and receiving device 13 of the data receiving end considerably deteriorate, a communication line adding operation is performed under the control of the data sending and receiving device 13 of the data receiving end to sufficiently obtain a transmission bandwidth for the transmission of the stream of multiplexed media data.

In detail, the transmission control unit 53 instructs the line interface 51 to connect new communication lines (or a new communication line) with the data sending and receiving device 13 of the data receiving end. Therefore, the new communication lines are connected with the data sending and receiving device 13 of the data receiving end. Thereafter, error tolerance levels optimum to the line states of all communication lines including the new communication lines are determined according to the line state information, a stream of multiplexed media data transmitted through the communication lines including the new communication lines is demultiplexed to pieces of media data according to data demultiplexing methods corresponding to the determined error tolerance levels, and the pieces of media data are output to subscribers. Also, communication line addition information indicating the addition of new communication lines and the number of added new communication lines or no addition of new communication lines is produced in the transmission control unit 53 according to the line state information, and the determined error tolerance levels and the communication line addition information are sent from the transmission control unit 53 to the operation mode change request outputting unit 54.

In the operation mode change request outputting unit 54, an operation mode change request indicating the changing to operation modes corresponding to the determined error tolerance levels is produced, and request data including the operation mode change request and the communication line addition information is output to the line interface 51.

Thereafter, the request data including the operation mode change request and the communication line addition information is output from the line interface 51 to the data sending and receiving device 13 of the data sending end through one communication line or the communication lines of the general communication network 14.

In the data sending and receiving device 13 of the data sending end, as shown in FIG. 5A, the request data including the operation mode change request and the communication line addition information is received in the line interface 51 and is sent to the operation mode change request receiving unit 55.

In the operation mode change request receiving unit 55, the request data including the operation mode change request and the communication line addition information is received, the operation mode change request and the communication line addition information are sent to the transmission control unit 53.

In the transmission control unit 53, the operation mode change request and the communication line addition information are received, operation modes corresponding to the error tolerance levels determined in the data sending and receiving device 13 of the data receiving end are selected according to the operation mode change request, and a plurality of data multiplexing methods relating to the selected operation modes are selected. Thereafter, pieces of media data are multiplexed according to the selected data multiplexing methods to produce a stream of multiplexed media data, and the stream of multiplexed media data is output to the data sending and receiving device 13 of the data receiving end. Also, in cases where the communication line addition information indicates the addition of new communication lines, the transmission control unit 53 instructs the line interface 51 to additionally connect a plurality of new communication lines, of which the number is indicated by the communication line addition information, with the line interface 51. Therefore, the new communication lines are connected with the data sending and receiving device 13 of the sending end.

Next, a data transmission and reception operation of the data sending and receiving devices 13 and a communication line disconnecting operation performed under the control of the data sending and receiving device 13 of the data receiving end will be described below. In this data transmission and reception operation, communication line disconnection information is sent from the data sending and receiving device 13 of a data receiving end to the data sending and receiving device 13 of the data sending end.

As shown in FIG. 5B, a current line state of each communication line connected with the data sending and receiving device 13 of the data receiving end is always detected in the line state monitoring unit 52, and line state information indicating the current line states of the communication lines is sent to the transmission control unit 53. Here, the new communication lines are included in the communication lines connecting the data sending and receiving device 13 of the data receiving end and the data sending and receiving device 13 of the data sending end. Therefore, when a stream of multiplexed media data sent from a plurality of communication lines of the general communication circuit 14 is received in the line interface 51, the stream of multiplexed media data is sent to the transmission control unit 53. In the transmission control unit 53, an error tolerance level optimum to the current line state of each communication line is determined according to the line state information, the stream of multiplexed media data is demultiplexed to pieces of media data according to data demultiplexing methods corresponding to the determined error tolerance levels, and the pieces of media data are output to subscribers. Also, the determined error tolerance levels of the communication lines are sent to the operation mode change request outputting unit 54.

Also, in cases where considerably-deteriorated line states of the communication lines are recovered to normal line states, high error tolerance levels of the communication lines are lowered to normal error tolerance levels. Therefore, it is not required to insert an appreciable amount of redundant data into the stream of multiplexed media data for the purpose of strengthening the error tolerance of the stream of multiplexed media data in the communication lines. In this case, the data sending and receiving device 13 of the data receiving end negotiates with the data sending and receiving device 13 of the data sending end for the disconnection of the new communication lines from the data sending and receiving device 13 of the data sending end.

In detail, in the transmission control unit 53, communication line disconnection information indicating the disconnection of the new communication lines from the data sending and receiving device 13 of the data sending end is produced according to the line state information, and the determined error tolerance levels and the communication line disconnection information are sent from the transmission control unit 53 to the operation mode change request outputting unit 54.

In the operation mode change request outputting unit 54, an operation mode change request indicating the changing to operation modes corresponding to the determined error tolerance levels is produced, and request data including the operation mode change request and the communication line disconnection information is output to the line interface 51.

Thereafter, the request data including the operation mode change request and the communication line disconnection information are output from the line interface 51 to the data sending and receiving device 13 of the data sending end through one communication line or the communication lines of the general communication network 14.

In the data sending and receiving device 13 of the data sending end, as shown in FIG. 5A, the request data including the operation mode change request and the communication line disconnection information is received in the line interface 51 and is sent to the operation mode change request receiving unit 55.

In the operation mode change request receiving unit 55, the request data including the operation mode change request and the communication line disconnection information is received, the operation mode change request and the communication line disconnection information are sent to the transmission control unit 53.

In the transmission control unit 53, the operation mode change request and the communication line disconnection information are received, the new communication lines are disconnected from the data sending and receiving device 13 of the data sending end according to the communication line disconnection information, and communication line disconnection completion information indicating the completion of the disconnection of the new communication lines is produced. The communication line disconnection completion information is sent to the operation mode change request outputting unit 54 to produce request data including the communication line disconnection completion information is. Also, in the transmission control unit 53, operation modes corresponding to the error tolerance levels determined in the data sending and receiving device 13 of the data receiving end are selected according to the operation mode change request, and a plurality of data multiplexing methods relating to the selected operation modes are selected. Thereafter, pieces of media data are multiplexed according to the selected data multiplexing methods to produce a stream of multiplexed media data. The stream of multiplexed media data and the request data including the communication line disconnection completion information are output to the data sending and receiving device 13 of the data receiving end through the communication lines of the communication network 14.

As shown in FIG. 5B, in the data sending and receiving device 13 of the data receiving end, the stream of multiplexed media data and the request data including the communication line disconnection completion information are received in the line interface 51. The stream of multiplexed media data is sent to the transmission control unit 53 and is demultiplexed to pieces of media data according to the data demultiplexing methods corresponding to the determined error tolerance levels, and the pieces of media data are output to subscribers. The request data including the communication line disconnection completion information is sent to the operation mode change request receiving unit 55. In the operation mode change request receiving unit 55, the request data including the, communication line disconnection completion information is received, and the communication line disconnection completion information is sent to the transmission control unit 53.

In response to the communication line disconnection completion information, the transmission control unit 53 instructs the line interface 51 to disconnect the new communication lines from the line interface 51. Therefore, the new communication lines are disconnected from the data sending and receiving device 13 of the data receiving end.

As is described above, in the fourth embodiment, in cases where current line states of the communication lines connecting the data sending and receiving devices 13 of the data transmission and receiving ends considerably deteriorate, not only a transmission control is performed for pieces of media data or a stream of multiplexed media data according to data multiplexing methods or data demultiplexing methods corresponding to high error tolerance levels, but also new communication lines connecting the data sending and receiving device 13 of the data sending end and the data sending and receiving device 13 of the data receiving end are added to sufficiently obtain a transmission bandwidth for the transmission of the stream of multiplexed media data. Accordingly, the media data can be prevented from being changed to faulty data or being lost during the multimedia communication, and the multimedia communication can be stably performed.

Also, in the fourth embodiment, in cases where considerably-deteriorated line states of the communication lines connecting the data sending and receiving devices 13 of the data transmission and receiving ends are recovered to normal line states, not only a transmission control is performed for pieces of media data or a stream of multiplexed media data according to data multiplexing methods or data demultiplexing methods corresponding to normal error tolerance levels, but also the new communication lines are disconnected from the data sending and receiving devices 13 of the data transmission and receiving ends. Accordingly, a transmission band for the multimedia communication can be efficiently used while the multimedia communication is stably performed.

In the fourth embodiment, each data sending and receiving device 13 is connected with a plurality of communication lines (or a communication line) for data transmission and is connected with a plurality of communication lines (or a communication line) for data reception, and the total number of communication lines for data transmission and reception is not fixed. Therefore, even though the number of communication lines for data transmission connected with each data sending and receiving device 13 is increased or decreased, the number of communication lines for data reception connected with the data sending and receiving device 13 is fixed. However, it is applicable that the number of communication lines connected with each data sending and receiving devices 13 be fixed. In this case, when the number of communication lines for data transmission connected with the data sending and receiving device 13 is increased (or decreased), the number of communication lines for data reception connected with the data sending and receiving device 13 is decreased (or increased). Also, when the number of communication lines for data reception is increased (or decreased), the number of communication lines for data transmission is decreased (or increased).

Embodiment 5

In the fourth embodiment, a plurality of new communication lines (or a new communication line) are additionally connected with each data sending and receiving device 13 in cases where the line states deteriorate, and the new communication lines (or the new communication line) connected with the data sending and receiving device 13 are disconnected from the data sending and receiving device 13 in cases where the line states ameliorate. Also, each communication line functions as a line for data sending or data reception.

In contrast, in a fifth embodiment, each communication line functions as a line for data transmission and functions as a line for data reception. Also, a data transfer rate allowed for a downward stream of multiplexed media data sent from a first data sending and receiving device 13 to a second data sending and receiving device 13 through a communication line (or a plurality of communication lines) is adjusted, and a data transfer rate allowed for an upward stream of multiplexed media data sent from the second data sending and receiving device 13 to the first data sending and receiving device 13 through the communication line (or the communication lines) is adjusted.

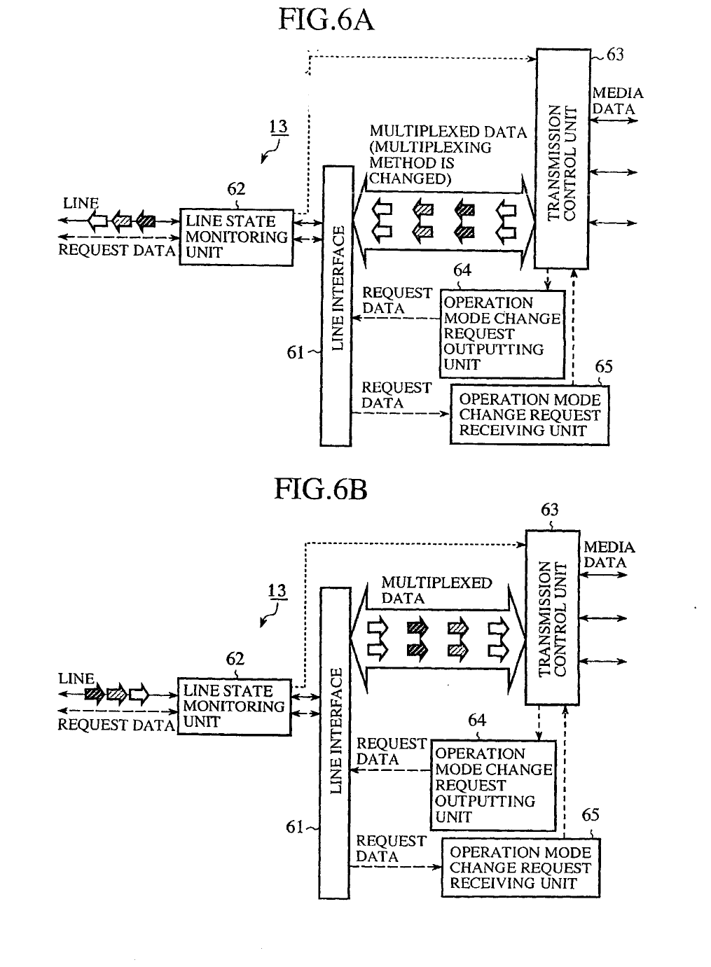

FIG. 6A is a block diagram showing the configuration of a first data sending and receiving device 13, from which a downward stream of multiplexed media data is sent out to a communication line and in which an upward stream of multiplexed media data transmitted through the communication line is received, according to a fifth embodiment of the present invention, and FIG. 6B is a block diagram showing the configuration of a second data sending and receiving device 13, from which the upward stream of multiplexed media data is sent out to the communication line and in which the downward stream of multiplexed media data transmitted through the communication line is received, according to the fifth embodiment.

In FIG. 6A and FIG. 6B, 61 indicates a line interface for receiving a stream of multiplexed media data transmitted through a single communication line or a plurality of communication lines at a receiving data transfer rate (hereinafter, the data reception through a single communication line is described) and sending a stream of multiplexed media data to the communication line at a sending data transfer rate.

62 indicates a line state monitoring unit for detecting a current line state relating to transmission quality in the communication line connected with the line interface 61 and producing line state information indicating the current line state of the communication line.

63 indicates a transmission control unit for determining an error tolerance level of the communication line according to the line state information sent from the line state monitoring unit 62, performing a transmission control for pieces of media data, which are planned to be sent from the line interface 61, according to an operation mode corresponding to the determined error tolerance level, performing a transmission control for a stream of multiplexed media data received in the line interface 61 according to an operation mode corresponding to the determined error tolerance level, instructing the line interface 61 to increase a ratio of an allowable sending data transfer rate to an allowable receiving data transfer rate in cases where a data amount of the stream of multiplexed media data planned to be sent from the line interface 61 is increased, and instructing the line interface 61 to decrease a ratio of an allowable sending data transfer rate to an allowable receiving data transfer rate in cases where data rate change information is received from the other data sending and receiving device connected through the communication line. Here, the sending data transfer rate denotes a data transfer rate of transmission data, which is sent out from a data sending and receiving device, in the communication line. Also, the receiving data transfer rate denotes a data transfer rate of transmission data, which is received in a data sending and receiving device, in the communication line.

64 indicates an operation mode change request outputting unit for producing an operation mode change request according to the error tolerance level determined in the transmission control unit 63, producing the data rate change information in cases where the data amount of the stream of multiplexed media data planned to be sent from the line interface 61 is increased, and outputting request data including both the operation mode change request and the data rate change information to the other data sending and receiving device.

65 indicates an operation mode change request receiving unit for receiving request data including both the operation mode change request and the data rate change information from the other data sending and receiving device and sending both the operation mode change request and the data rate change information to the transmission control unit 63.

Next, a data transmission and reception operation of the first and second data sending and receiving devices 13 will be described below on condition that a total transmission bandwidth (or a sum of an allowable sending data transfer rate and an allowable receiving data transfer rate) in the communication line is fixed.

In cases where a data amount of a downward stream of multiplexed media data planned to be sent from the first data sending and receiving device 13 shown in FIG. 6A to the second data sending and receiving device 13 shown in FIG. 6B is increased or in cases where a degree of importance of the downward stream of multiplexed media data is heightened, it is required to heighten an allowable data transfer rate for the downward stream of multiplexed media data in the communication line.

In this case, in the first data sending and receiving device 13, data rate change information indicating a request of the increase of a data transfer rate for the downward stream of multiplexed media data is produced in the transmission control unit 63, an operation mode change request indicating an operation mode corresponding to a high error tolerance level is produced in the operation mode change request outputting unit 64, request data including both the operation mode change request and the data rate change information is sent from the operation mode change request outputting unit 64 to the second data sending and receiving device 13. Also, the transmission control unit 63 instructs the line interface 61 to decrease an allowable receiving data transfer rate allocated to the first data sending and receiving device 13 and to increase an allowable sending data transfer rate allocated to the first data sending and receiving device 13 by a degree of the decrease of the allowable receiving data transfer rate. Also, the error tolerance level of the communication line is heightened in the transmission control unit 63 regardless of the line state information, and pieces of media data are multiplexed according to an operation mode corresponding to the high error tolerance level to produce the downward stream of multiplexed media data.

In the second data sending and receiving device 13 shown in FIG. 6B, when the request data including both the operation mode change request and the data rate change information is received in the line interface 61, the request data is sent to the operation mode change request receiving unit 65, and both the operation mode change request and the data rate change information are sent from the operation mode change request receiving unit 65 to the transmission control unit 63. In the transmission control unit 63, an allowable sending data transfer rate allocated to the second data sending and receiving device 13 is decreased according to the data rate change information, and an allowable receiving data transfer rate allocated to the second data sending and receiving device 13 is increased according to the data rate change information by a degree of the decrease of the allowable sending data transfer rate. Also, an operation mode corresponding to the high error tolerance level is selected.

Therefore, when the downward stream of multiplexed media data is sent from the first data sending and receiving device 13 to the second data sending and receiving device 13 through the communication line in which the allowable sending data transfer rate allocated to the first data sending and receiving device 13 is increased (in other words, the allowable receiving data transfer rate allocated to the second data sending and receiving device 13 is increased), the downward stream of multiplexed media data is demultiplexed in the transmission control unit 63 according to the selected operation mode.

Also, in cases where a data amount of an upward stream of multiplexed media data planned to be sent from the second data sending and receiving device 13 shown in FIG. 6B to the first data sending and receiving device 13 shown in FIG. 6A is increased or in cases where a degree of importance of the upward stream of multiplexed media data is heightened, it is required to heighten an allowable data transfer rate for the upward stream of multiplexed media data in the communication line.

In this case, in the second data sending and receiving device 13, data rate change information (or a data rate change request) indicating a request of the increase of a data transfer rate for the upward stream of multiplexed media data is produced in the transmission control unit 63, an operation mode change request indicating an operation mode corresponding to a high error tolerance level is produced in the operation mode change request outputting unit 64, request data including both the operation mode change request and the data rate change information is sent from the operation mode change request outputting unit 64 to the first data sending and receiving device 13. Also, the transmission control unit 63 instructs the line interface 61 to decrease an allowable receiving data transfer rate allocated to the second data sending and receiving device 13 and to increase an allowable sending data transfer rate allocated to the second data sending and receiving device 13 by a degree of the decrease of the allowable receiving data transfer rate. Also, the error tolerance level of the communication line is heightened in the transmission control unit 63 regardless of the line state information, and pieces of media data are multiplexed according to an operation mode corresponding to the high error tolerance level to produce the upward stream of multiplexed media data.

In the first data sending and receiving device 13 shown in FIG. 6A, when the request data including both the operation mode change request and the data rate change information is received in the line interface 61, the request data is sent to the operation mode change request receiving unit 65, and both the operation mode change request and the data rate change information are sent from the operation mode change request receiving unit 65 to the transmission control unit 63. In the transmission control unit 63, an allowable sending data transfer rate allocated to the second data sending and receiving device 13 is decreased according to the data rate change information, and an allowable receiving data transfer rate allocated to the second data sending and receiving device 13 is increased according to the data rate change information by a degree of the decrease of the allowable sending data transfer rate. Also, an operation mode corresponding to the high error tolerance level is selected.

Therefore, when the upward stream of multiplexed media data is sent from the second data sending and receiving device 13 to the first data sending and receiving device 13 through the communication line in which the allowable sending data transfer rate allocated to the second data sending and receiving device 13 is increased (in other words, the allowable receiving data transfer rate allocated to the first data sending and receiving device 13 is increased), the upward stream of multiplexed media data is demultiplexed in the transmission control unit 63 according to the selected operation mode.

For example, in cases where the line state of the communication line connected with the first data sending and receiving device 13 considerably deteriorate, the error tolerance level for the communication line is considerably heightened so as to stably transmit both a downward stream of multiplexed media data and an upward stream of multiplexed media data through the communication line. Therefore, it is required to insert an appreciable amount of redundant data (or error correction codes) into each stream of multiplexed media data for the purpose of strengthening the error tolerance of the streams of multiplexed media data in the communication line. In this case, a transmission bandwidth for each stream of multiplexed media data is undesirably reduced. In this embodiment, a degree of importance of the downward stream of multiplexed media data output from the first data sending and receiving device 13 is compared with a degree of importance of the upward stream of multiplexed media data output from the second data sending and receiving device 13. In cases where the degree of importance of the downward stream of multiplexed media data is higher than that of the upward stream of multiplexed media data, an allowable sending data transfer rate allocated to the first data sending and receiving device 13 is increased, an allowable receiving data transfer rate allocated to the first data sending and receiving device 13 is decreased, an allowable receiving data transfer rate allocated to the second data sending and receiving device 13 is increased, and an allowable sending data transfer rate allocated to the second data sending and receiving device 13 is decreased. In contrast, in cases where the degree of importance of the upward stream of multiplexed media data is higher than that of the downward stream of multiplexed media data, an allowable receiving data transfer rate allocated to the first data sending and receiving device 13 is increased, an allowable sending data transfer rate allocated to the first data sending and receiving device 13 is decreased, an allowable sending data transfer rate allocated to the second data sending and receiving device 13 is increased, and an allowable receiving data transfer rate allocated to the second data sending and receiving device 13 is decreased.

Also, in cases where a considerably-deteriorated line state of the communication line is recovered to a normal line state, the high error tolerance level for the communication line is lowered to a normal error tolerance level. Therefore, it is not required to insert an appreciable amount of redundant data into both the downward stream of multiplexed media data and the upward stream of multiplexed media data for the purpose of strengthening the error tolerance of the streams of multiplexed media data in the communication line. In this case, a ratio of the sending data transfer rate to the receiving data transfer rate in the first data sending and receiving device 13 and a ratio of the receiving data transfer rate to the sending data transfer rate in the second data sending and receiving device 13 are set according to a ratio of a data amount of the downward stream of multiplexed media data to a data amount of the upward stream of multiplexed media data, the pieces of media data are multiplexed according to the normal error tolerance level in the first data sending and receiving device 13 to produce the downward stream of multiplexed media data, and the pieces of media data are multiplexed according to the normal error tolerance level in the second data sending and receiving device 13 to produce the upward stream of multiplexed media data.

Next, a data transmission and reception operation of the first and second data sending and receiving devices 13 will be described below on condition that a total transmission bandwidth (or a sum of an allowable sending data transfer rate and an allowable receiving data transfer rate) in the communication line is not fixed.

In cases where it is required to heighten a sending data transfer rate (or a receiving data transfer rate) in the first data sending and receiving device 13, a sending data transfer rate (or a receiving data transfer rate) allocated to the first data sending and receiving device 13 is increased in the transmission control unit 63. Also, in cases where there is no margin of a receiving data transfer rate (or a sending data transfer rate) allocated to the first data sending and receiving device 13, it is not required to decrease the receiving data transfer rate (or the sending data transfer rate) allocated to the first data sending and receiving device 13. However, in cases where there is a wide margin of a receiving data transfer rate (or a sending data transfer rate) allocated to the first data sending and receiving device 13, the transmission control unit 63 of the first data sending and receiving device 13 instructs the line interface 61 to decrease the receiving data transfer rate (or the sending data transfer rate) allocated to the first data sending and receiving device 13 by a degree of the increase of the sending data transfer rate (or the receiving data transfer rate).

Also, it is required to heighten a sending data transfer rate (or a receiving data transfer rate) in the second data sending and receiving device 13, a sending data transfer rate (or a receiving data transfer rate) allocated to the second data sending and receiving device 13 is increased in the transmission control unit 63. Also, in cases where there is no margin of a receiving data transfer rate (or a sending data transfer rate) allocated to the second data sending and receiving device 13, it is not required to decrease the receiving data transfer rate (or the sending data transfer rate) allocated to the second data sending and receiving device 13. However, in cases where there is a wide margin of a receiving data transfer rate (or a sending data transfer rate) allocated to the second data sending and receiving device 13, the transmission control unit 63 of the second data sending and receiving device 13 instructs the line interface 61 to decrease the receiving data transfer rate (or the sending data transfer rate) allocated to the second data sending and receiving device 13 by a degree of the increase of the sending data transfer rate (or the receiving data transfer rate).

As is described above, in the fifth embodiment, a data amount or a degree of importance in a downward stream of multiplexed media data is compared with a data amount or a degree of importance in an upward stream of multiplexed media data, and a data transfer rate for the stream of multiplexed media data corresponding to a large data amount or a high degree of importance is increased. Accordingly, each piece of media data can be prevented from being changed to faulty data or being lost during the multimedia communication, and the multimedia communication can be stably performed.

Also, in the fifth embodiment, in cases where a considerably-deteriorated line state of the communication line connecting the data sending and receiving devices 13 is recovered to a normal line state, not only a transmission control is performed for pieces of media data or a stream of multiplexed media data according to a data multiplexing method or a data demultiplexing method corresponding to the normal error tolerance level, but also the ratio of the sending data transfer rate to the receiving data transfer rate in each data sending and receiving device 13 is set according to a data amount ratio or an importance ratio. Accordingly, a transmission band for the multimedia communication can be efficiently used while the multimedia communication is stably performed.

Also, in the fifth embodiment, in cases where the total transmission bandwidth is not fixed, it is applicable that another data communication be performed by using a non-used transmission bandwidth. Also, it is applicable that communication lines corresponding to non-used transmission bandwidth be disconnected from the data sending and receiving devices 13 to reduce the cost of the multimedia communication.

In the fifth embodiment, the first and second data sending and receiving devices 13 are connected with each other through a single communication line in an asymmetrical digital subscriber line (ADSL) on condition that an upward stream of multiplexed media data and a downward stream of multiplexed media data are simultaneously transmitted through the communication line. However, it is applicable that the first and second data sending and receiving devices 13 be connected with each other through a plurality of communication lines on condition that an upward stream of multiplexed media data and a downward stream of multiplexed media data are simultaneously transmitted through the communication lines.

What is claimed is:

1. A data communication device comprising:
a line state monitoring unit for detecting a line state relating to transmission quality in a communication line and producing line state information indicating the line state; and
a transmission control unit, having a plurality of operation modes corresponding to a plurality of error tolerance levels different from each other, for selecting a specific operation mode from the operation modes according to the line state information produced by the line state monitoring unit and performing a transmission control for transmission data, which is planned to be sent out to the communication line, according to the specific operation mode.

2. A data communication device according to claim 1, wherein the specific operation mode is changed to another operation mode by the transmission control unit in response to the change of the line state indicated by the line state information during the transmission of the data without suspending the transmission of the data, and the transmission control is performed for the transmission data according to the changed operation mode by the transmission control unit.

3. A data communication device according to claim 1, wherein the transmission control unit has a plurality of data multiplexing methods corresponding to the operation modes, a specific multiplexing method is selected from the multiplexing methods by the transmission control unit according to the line state information produced by the line state monitoring unit, and pieces of transmission data, which are planned to be sent out to the communication line, are multiplexed with each other to a stream of multiplexed transmission data according to the specific multiplexing method.

4. A data communication device according to claim 1, wherein the specific operation mode is changed to another operation mode corresponding to a high error tolerance level by the transmission control unit according to the line state information in cases where the line state information indicates a deteriorated line state, and the specific operation mode is changed to another operation mode corresponding to a low error tolerance level by the transmission control unit according to the line state information in cases where the line state information indicates an ameliorated line state.

5. A data communication device according to claim 1, further comprising:
an operation mode change request receiving unit for receiving an operation mode change request from a second data communication device and sending the operation mode change request to the transmission control unit to make the transmission control unit perform the transmission control for the transmission data according to a particular operation mode indicated by the operation mode change request.

6. A data communication device according to claim 1, further comprising:
a line interface, connected with the communication line, for sending the transmission data to the communication line,
wherein the transmission control unit controls the line interface to add a new communication line connected with the line interface, in cases where the specific operation mode corresponds to a high error tolerance level, and to disconnect the new communication line from the line interface in cases where the specific operation mode is changed to a low error tolerance level.

7. A data communication device according to claim 1, further comprising:
a line interface for receiving and sending the transmission data to/from the communication line,
wherein the transmission control unit controls the line interface to increase a data transfer rate for data sending while decreasing a data transfer rate for data reception by a degree of the increase of the data transfer rate for data sending in cases where the specific operation mode is changed to a particular operation mode corresponding to a high error tolerance level in the transmission control unit to perform the transmission control for the transmission data sent out to the communication line according to the particular operation mode.

8. A data communication device according to claim 1, further comprising:
a line interface for receiving and sending the transmission data from/to the communication line,
wherein the transmission control unit controls the line interface to decrease a data transfer rate for data sending while increasing a data transfer rate for data reception by a degree of the decrease of the data transfer rate for data sending in cases where the specific operation mode is changed to a particular operation mode corresponding to a low error tolerance level in the transmission control unit to perform the transmission control for the transmission data sent out to the communication line according to the particular operation mode.

9. A data communication device comprising:
a line state monitoring unit for detecting a line state relating to transmission quality in a communication line and producing line state information indicating the line state;
a transmission control unit, having a plurality of operation modes corresponding to a plurality of error tolerance levels different from each other, for selecting a specific operation mode from the operation modes according to the line state information produced by the line state monitoring unit and performing a transmission control for transmission data, which is sent out to the communication line or is received through the communication line, according to the specific operation mode; and
an operation mode change request outputting unit for requesting of a second data communication device, with which communication is performed through the communication line, that an operation mode selected in the second data communication device is changed to the specific operation mode selected by the transmission control unit.

10. A data communication device according to claim 9, wherein the request of the operation mode change request outputting unit to the second data communication device is performed during the sending or reception of the transmission data without suspending the sending or reception of the transmission data.

11. A data communication device according to claim 9, wherein the transmission control unit has a plurality of data multiplexing methods corresponding to the operation modes, a specific multiplexing method is selected from the multiplexing methods by the transmission control unit according to the line state information produced by the line state monitoring unit, and the operation mode change request outputting unit requests the second data communication device, during the transmission of the data without suspending the transmission of the data, to select the specific multiplexing method.

12. A data communication device according to claim 9, wherein the operation mode change request outputting unit requests the second data communication device to change the specific operation mode to an operation mode corresponding to a high error tolerance level in cases where the line state information produced by the line state monitoring unit indicates a deteriorated line state, and the operation mode change request outputting unit requests the second data communication device to change the specific operation mode to an operation mode corresponding to a low error tolerance level in cases where the line state information produced by the line state monitoring unit indicates an ameliorated line state.

13. A data communication device according to claim 9, further comprising:
an operation mode change request receiving unit for receiving an operation mode change request from the second data communication device, and sending the operation mode change request to the transmission control unit to make the transmission control unit perform the transmission control for the transmission data, which is received through the communication line or is sent out to the communication line, according to a particular operation mode indicated by the operation mode change request.

14. A data communication device according to claim 9, further comprising:
a line interface, connected with the communication line, for receiving or sending the transmission data from/to the communication line,
wherein the transmission control unit controls the line interface to add a new communication line connected with the line interface, in cases where the specific operation mode corresponds to a high error tolerance level, and to disconnect the new communication line, which is connected with the line interface, from the line interface in cases where the specific operation mode corresponding to the high error tolerance level is changed to that corresponding to a low error tolerance level.

15. A data communication device according to claim 13, further comprising:
a line interface, connected with the communication line, for receiving or sending the transmission data from/to the communication line,
wherein the operation mode change request receiving unit further receives a communication line adding request or a communication line disconnecting request from the second data communication device, the operation mode change request receiving unit sends the communication line adding request or the communication line disconnecting request to the transmission control unit, the transmission control unit controls the line interface to add a new communication line connected with the line interface according to the communication line adding request and changes the specific operation mode to an operation mode corresponding to a high error tolerance level according to the operation mode change request, and the transmission control unit controls the line interface to disconnect the new communication line, which is connected with the line interface, from the line interface according to the communication line disconnecting request and changes the specific operation mode to an operation mode corresponding to a low error tolerance level according to the operation mode change request.

16. A data communication device according to claim 9, wherein the operation mode change request outputting unit requests the second data communication device to add a new communication line connected with the second data communication device in cases where the operation mode change request outputting unit requests the second data communication device to change the specific operation mode to an operation mode corresponding to a high error tolerance level, and the operation mode change request outputting unit requests the second data communication device to disconnect the new communication line, which is connected with the second data communication device, from the second data communication device in cases where the operation mode change request outputting unit requests the second data communication device to change the operation mode corresponding to the high error tolerance level to an operation mode corresponding to a low error tolerance level.

17. A data communication device according to claim 9, further comprising:
a line interface for receiving and sending the transmission data from/to the communication line,
wherein the transmission control unit controls the line interface to increase a data transfer rate for data sending while decreasing a data transfer rate for data reception by a degree of the increase of the data transfer rate for data sending, in cases where the specific operation mode is changed to a particular operation mode corresponding to a high error tolerance level in the transmission control unit to perform the transmission control for the transmission data sent out to the communication line according to the particular operation mode, and to increase a data transfer rate for data reception while decreasing a data transfer rate for data sending by a degree of the increase of the data transfer rate for data reception in cases where the specific operation mode is changed to a particular operation mode corresponding to a high error tolerance level in the transmission control unit to perform the transmission control for the transmission data received through the communication line according to the particular operation mode.

18. A data communication device according to claim 9, further comprising:
a line interface for receiving and sending the transmission data from/to the communication line,
wherein the transmission control unit controls the line interface to decrease a data transfer rate for data sending while increasing a data transfer rate for data reception by a degree of the decrease of the data transfer rate for data sending, in cases where the specific operation mode is changed to a particular operation mode corresponding to a low error tolerance level in the transmission control unit to perform the transmission control for the transmission data sent out to the communication line according to the particular operation mode, and to decrease a data transfer rate for data reception while increasing a data transfer rate for data sending by a degree of the decrease of the data transfer rate for data reception in cases where the specific operation mode is changed to a particular operation mode corresponding to a low error tolerance level in the transmission control unit to perform the transmission control for the transmission data received through the communication line according to the particular operation mode.

19. A data communication device according to claim 13, further comprising:
a line interface for receiving and sending the transmission data from/to the communication line,
wherein the operation mode change request receiving unit further receives a data rate change request from the second data communication device, the operation mode change request receiving unit sends the data rate change request to the transmission control unit, the transmission control unit controls the line interface to increase a data transfer rate for data sending while decreasing a data transfer rate for data reception by a degree of the increase of the data transfer rate for data sending according to the data rate change request, in cases where the specific operation mode is changed to a particular operation mode corresponding to a high error tolerance level in the transmission control unit according to the operation mode change request to perform the transmission control for the transmission data sent out to the communication line according to the particular operation mode, and the transmission control unit controls the line interface to increase a data transfer rate for data reception while decreasing a data transfer rate for data sending by a degree of the increase of the data transfer rate for data reception according to the data rate change request in cases where the specific operation mode is changed to a particular operation mode corresponding to a high error tolerance level in the transmission control unit according to the operation mode change request to perform the transmission control for the transmission data received through the communication line according to the particular operation mode.

20. A data communication device according to claim 9, wherein the operation mode change request outputting unit requests the second data communication device to increase a data transfer rate for data sending while decreasing a data transfer rate for data reception by a degree of the increase of the data transfer rate for data sending, in cases where the operation mode change request outputting unit requests the second data communication device to change the specific operation mode to a particular operation mode corresponding to a high error tolerance level in the transmission control unit according to the operation mode change request to perform the transmission control for the transmission data sent out to the communication line according to the particular operation mode, and the operation mode change request outputting unit requests the second data communication device to increase a data transfer rate for data reception while decreasing a data transfer rate for data sending by a degree of the increase of the data transfer rate for data reception in cases where the operation mode change request outputting unit requests the second data communication device to change the specific operation mode to a particular operation mode corresponding to a high error tolerance level in the transmission control unit according to the operation mode change request to perform the transmission control for the transmission data received through the communication line according to the particular operation mode.
